(19) United States
(12) Patent Application Publication
(10) Pub. No.: US 2011/0120264 A1
(43) Pub. Date: May 26, 2011

(54) MANUAL DRIVE FOR AN ELECTRIC-MOTOR ACTUATING DRIVE

(75) Inventor: Herbert MOELLER, Bad Oeynhausen (DE)

(73) Assignee: ABB Technology AG, Zurich (CH)

(21) Appl. No.: 12/950,290

(22) Filed: Nov. 19, 2010

(30) Foreign Application Priority Data
Nov. 20, 2009 (DE) 10 2009 054 120.9

(51) Int. Cl. F16H 37/00

(52) U.S. Cl. 74/625

(57) ABSTRACT

A manual drive is provided for an electric-motor actuating drive for controlling fittings for process automation. The manual drive includes a constraining transmission, whose output drive can be operatively connected for braking purposes to the motor shaft, such that force can be transmitted, via a detachable clutch which is operable electrically.

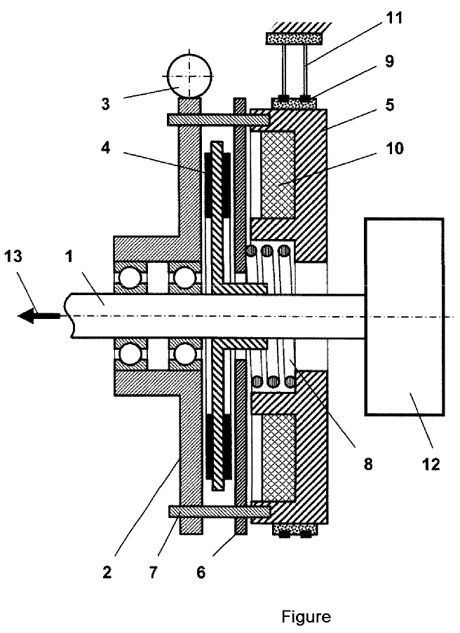

### RELATED APPLICATION

This application claims priority under 35 U.S.C. §119 to German Patent Application No. 10 2009 054 120.9 filed in Germany on Nov. 20, 2009, the entire content of which is hereby incorporated by reference in its entirety.

### FIELD

The present disclosure relates to a manual drive for an electric-motor actuating drive, such as an actuating drive for controlling fittings for process automation, for example . . .

### BACKGROUND INFORMATION

In actuating drives such as these, an electric motor drives a fitting, which may be in the form of a valve, flap, slide or the like, via a transmission for matching the actuating movement and actuating time to a particular application. Actuating drives such as these are equipped with a manual drive, in order to operate the fitting in the event of a power failure or damage to the electric motor.

DE 42 39 947 discloses an actuating drive such as this with a variable speed transmission. A worm gear shaft with a worm gear is provided for the manual drive and engages in an external tooth system on a hollow wheel. Intermediate gearwheels of the motor drive engage in the interior of the hollow wheel. The worm gear shaft of the manual drive is at rest while the motor drive is in operation. The manual drive consists of a handwheel which is arranged on a shaft stub with a lateral pin. The shaft stub can move axially and is arranged such that it is aligned with the worm gear shaft of the manual drive. The worm gear shaft of the manual drive has a slot, with a corresponding lateral pin, on the handwheel side.

In order to make use of the manual drive, the handwheel can be used to move the shaft stub axially in the direction of the worm gear shaft, and the lateral pin can be made to engage in the slot in the stationary worm gear shaft, by rotation of the handwheel.

However, particularly for compact actuating drives, a variable speed transmission arrangement such as this is complex and can occupy too much space.

DE 27 58 443 discloses a switching device for manual and motor operation of an actuating drive, in which draw keys with coupling claws are guided in grooves in a drive column, and disconnect the operative connection between the electric motor and the drive column when the manual drive is operated. The handwheel of the manual drive is equipped with driver elements which engage in further coupling claws after disconnection of the operative connection between the electric motor and the drive column. In this case, the braking effect of the electric motor is lost in an uncontrolled manner between the switching states of motor drive and manual drive. Furthermore, the large number of parts in the switching device are considered to be disadvantageous.

### SUMMARY

An exemplary embodiment provides an actuating drive which includes a fitting, and a transmission wheel configured to connect an electric motor to the fitting. The exemplary actuating drive also includes a detachable clutch configured to be operated electrically, and a motor shaft. In addition, the exemplary actuating drive includes a manual drive, which includes a constraining transmission having an output drive. The output drive of the constraining transmission is operatively connected for braking to the motor shaft to transmit force via the detachable clutch.

### BRIEF DESCRIPTION OF THE DRAWINGS

Additional refinements, advantages and features of the present disclosure are described in more detail below with reference to exemplary embodiments illustrated in the drawing, which shows a partially sectioned view of an actuating drive according to an exemplary embodiment of the present disclosure

### DETAILED DESCRIPTION

Exemplary embodiments of the present disclosure provide a manual drive for an electric-motor actuating drive, which is composed of a small number of components, is of simple design, and in which the operative connection is maintained in a controlled manner to the output drive when the electric motor is switched off.

Exemplary embodiments of the present disclosure are based on an actuating drive, in which an electric motor is operatively connected to a fitting via a transmission, and which is equipped with a manual drive.

According to an exemplary embodiment, the manual drive includes a constraining transmission, whose output drive can be operatively connected for braking purposes to the motor shaft, such that force can be transmitted, via a detachable clutch which is operable electrically.

According to an exemplary embodiment, in the rest position, the electric motor is switched off. No current flows through the clutch. The manual drive can be engaged. The electric motor can be braked by the constraining transmission of the manual drive. The actuating drive can be moved manually by the manual drive.

During an actuating operation, the electric motor can be switched on and current can flow through the clutch. The manual drive is disengaged and does not exert any braking effect on the motor shaft. The rotation direction and the rotation speed of the shaft are based on the motor control and the load on the motor shaft.

According to an exemplary embodiment, the manual drive is physically compact, thereby allowing the use of canned motors, which are distinguished by a high ingress detection class against environmental conditions.

A manual drive such as this can advantageously be produced with few, technically simple components. Furthermore, the exemplary manual drive is highly space-saving and is therefore consistent with the compact design of actuated drives. Furthermore, the exemplary manual drive can replace the braking motor that is required for operation of non-self-constraining actuating drives.

According to an exemplary embodiment of the present disclosure, the transmission of the manual drive includes a worm gear transmission stage. This exemplary arrangement results in constriction in the transmission in a simple manner.

According to an exemplary embodiment of the present disclosure, the transmission of the manual drive includes a block catch. This exemplary arrangement eliminates reactions from the fitting via the motor shaft in the rest position.

Exemplary embodiments of the present disclosure will be explained in more detail with reference to the drawing. The drawing shows a partially sectioned view of details of an actuating drive for understanding features of exemplary embodiments of the present disclosure.

As illustrated in the drawing, a transmission wheel (e.g., a gear) 2 is mounted rotatably on a drive shaft 1. The drive shaft 1 is firmly connected to an electric motor 12.

The transmission wheel 2 can be in the form of a worm gear, for example, and is supported on a mating wheel 3. The mating wheel 3 can be in the form of a self-constraining worm gearwheel or helical wheel with self-constriction, for example. The mating wheel 3 is mounted in a transmission housing, and is supported axially in the transmission housing. A handwheel of the manual drive is arranged on the shaft of the mating wheel 3, for manual movement of the fitting.

Furthermore, a brake disk 4 is arranged on the drive shaft 1, is fixed in rotation and can be moved axially, for example, by means of a wedge profile. In the illustrated exemplary embodiment, the brake disk 4 is arranged between the transmission wheel 2 and an armature disk 6, with the armature disk 6 being pushed in the direction of the transmission wheel 2 by the force of a spring 8.

A brake coil former 5 is firmly connected via stud bolts 7 to the transmission wheel 2, at a distance from the transmission wheel 2. A brake coil 10 is arranged within the brake coil former 5 and is connected to sliprings of a slipring body 9. Fixed-position wipers 11 rest on the sliprings of the slipring body 9 and pass the brake current from a fixed-position feed via the slipring body 9 to the rotationally moving brake coil 10.

The armature disk 6 is arranged such that it is rotationally fixed to the stud bolt 7, but can move axially, between the brake disk 4 and the brake coil former 5.

According to an exemplary embodiment, to achieve the braking and holding torque, the armature disk 6, when in the rest position, is pushed by means of the spring 8 against the transmission wheel 2 of the self-constraining transmission arrangement.

According to another exemplary embodiment, the mating wheel 3 can be in the form of a spur gear and be secured against rotation by a catch.

In the rest position, the electric motor 12 is switched off and no current flows through the brake coil 10. In this case, the brake disk 4 is blocked via the spring 8 between the transmission wheel 2 and the armature disk 6. When the handwheel is rotated, the rotary movement on the mating wheel 3 produces a rotary movement of the transmission wheel 2. The brake disk 4 is caused to carry out the same rotary movement by the fixed connection to the armature disk 6. Its rotationally fixed coupling to the drive shaft 1 ensures that this shaft is rotated at the same rotation speed. The drive shaft 1 is firmly connected 13 to a connected step-down transmission, which includes an appropriate output-drive element. When a driving load torque in the reverse direction is present via the output-drive element in the step-down transmission, then this is absorbed in the opposite sequence by the supporting mating wheel. Manual operation is initiated in this way when the motor is switched off.

During an actuating operation, the electric motor 12 is switched on and current passes through the brake coil 10. In this case, the magnetic field that is produced ensures that the armature disk 6 releases the brake disk 4, and that the brake disk 4 can rotate freely.

The variables introduced by the electric motor 12, such as the rotation speed and torque, are transmitted to the drive shaft 1 and further via the connection 13 to the step-down transmission and the corresponding output-drive element. Motor operation is initiated in this way.

Manual operation when the electric motor 12 is switched on is prevented by the current passing through the brake coil 10.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Drive shaft
2 Transmission wheel
3 Mating wheel
4 Brake disk
5 Brake coil former
6 Armature disk
7 Stud bolt
8 Spring
9 Slipring body
10 Brake coil
11 Wiper
12 Electric motor
13 Connection

What is claimed is:

1. An actuating drive comprising:
a fitting;
a transmission wheel configured to connect an electric motor to the fitting;
a detachable clutch configured to be operated electrically;
a motor shaft; and
a manual drive including a constraining transmission having an output drive, the output drive of the constraining transmission being operatively connected for braking to the motor shaft to transmit force via the detachable clutch.

2. The actuating drive as claimed in claim 1, wherein the transmission of the manual drive comprises a worm-gear transmission stage.

3. The actuating drive as claimed in claim 1, wherein the transmission of the manual drive has a blocking catch.

4. The actuating drive as claimed in claim 1, wherein, in a rest position, the manual drive is configured to be engaged while no current flows through the detachable clutch, and the transmission of the manual drive is configured to brake the electric motor.

5. The actuating drive as claimed in claim 4, wherein, during an actuating operation, the detachable clutch is configured to pass current therethrough while the electric motor is switched on, and the manual drive is configured to be disengaged.

6. The actuating drive as claimed in claim 1, wherein, during an actuating operation, the detachable clutch is configured to pass current therethrough while the electric motor is switched on, and the manual drive is configured to be disengaged.
